(19) United States
(12) Patent Application Publication
(10) Pub. No.: US 2008/0116756 A1
(43) Pub. Date: May 22, 2008

(54) MOTOR

(76) Inventors: Sean CHANG, Taoyuan Hsien (TW); Li-Ming Chen, Taoyuan Hsien (TW)

Correspondence Address: BIRCH STEWART KOLASCH & BIRCH, PO BOX 747, FALLS CHURCH, VA, 22040-0747, US

(21) Appl. No.: 11/938,871

(22) Filed: Nov. 13, 2007

(30) Foreign Application Priority Data
Nov. 17, 2006 (TW) 095142584

(51) Int. Cl. H02K 5/24; H02K 7/08

(52) U.S. Cl. 310/90; 310/51

(57) ABSTRACT

A motor includes a bushing, a stator, a rotor and a magnetic body. The stator is telescoped to the bushing. The rotor has a shaft and a magnetic element. The shaft is disposed in the bushing, and the magnetic element is disposed corresponding to the stator structure. The magnetic body is disposed between the stator and the bushing.

### CROSS REFERENCE TO RELATED APPLICATIONS

This Non-provisional application claims priority under 35 U.S.C. §119(a) on Patent Application No(s). 095142584 filed in Taiwan, Republic of China on Nov. 17, 2006, the entire contents of which are hereby incorporated by reference.

### BACKGROUND OF THE INVENTION

1. Field of Invention

The invention relates to a motor and, in particular, to a motor capable of improving the electromagnetic effect.

2. Related Art

Motors can transform the electricity into mechanical energy. They are widely used in various kinds of mechanical devices such as the fans, optical disk drive or hard disk drive. Although the motors are developed into many types, their operations are obeying the same principle, the electromagnetic effect.

As shown in FIG. 1, a conventional motor 1 includes a shaft 11, a permeable shell 12, a magnetic ring 13 and a bushing 14. The shaft 11 is connected with the permeable shell 12 and is disposed in the bushing 14. The magnetic ring 13 is connected with the inner wall of the permeable shell 12. The motor 1 further includes a coreless coil 15 disposed between the bushing 14 and the magnetic ring 13. The coreless coil 15 is located corresponding to the magnetic ring 13.

When a voltage is applied to the coreless coil 15, an electromagnetic effect will occur between the coreless coil 15 and the magnetic ring 13 so as to drive the magnetic ring 13 and the permeable shell 12 to rotate. However, the electromagnetic effect caused by the coreless coil 15 and magnetic ring 13 is improper and will induce high frequency noise. In addition, large current is necessary for generating the electromagnetic effect, and thus the coreless coil 15 will generate a lot of heat resulting in poor efficiency of the motor 1.

Therefore, it is an important subject to provide an improved motor having good electromagnetic effect so as to avoid the high frequency noise and decrease the current applied to the coil.

### SUMMARY OF THE INVENTION

In view of the foregoing, the invention is to provide a motor having good electromagnetic effect, which can avoid the high frequency noise, decrease the current applied to the coil, and thus enhance the performance of the motor.

To achieve the above, the invention discloses a motor including a bushing, a stator, a rotor and a magnetic body. The stator is telescoped to the bushing. The rotor includes a shaft disposed in the bushing and a magnetic element disposed corresponding to the stator. The magnetic body is dispose between the stator and the bushing.

As mentioned above, the motor of the invention has a magnetic body disposed between the stator and the bushing, so that the electromagnetic effect between the coil of the stator and the magnetic element of the rotor can be improved. Accordingly, the high frequency noise can be avoided. In addition, the improved electromagnetic effect allows the coil reaching the same performance with lower current. Therefore, the heat generated by the coil can be reduced so as to improve the performance of the motor.

### BRIEF DESCRIPTION OF THE DRAWINGS

The invention will become more fully understood from the subsequent detailed description and the accompanying drawings, which are given by way of illustration only, and thus is not limitative of the present invention, and wherein:

FIG. 1 is a cross-sectional view showing a conventional motor; and

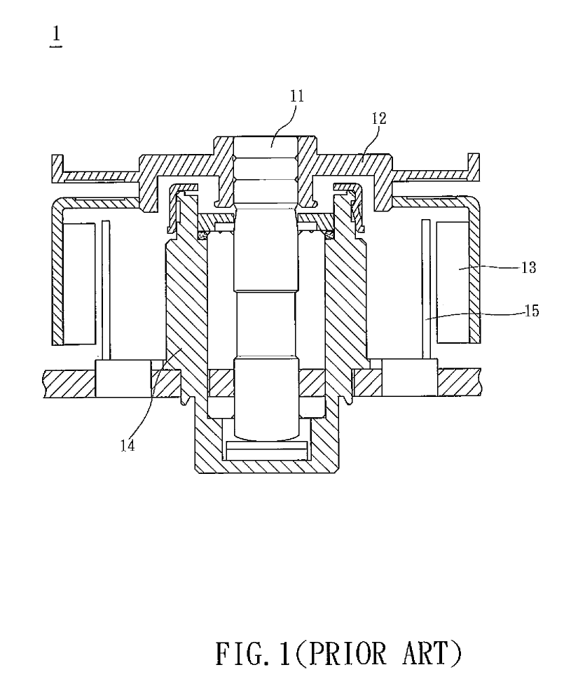

FIG. 2 is a cross-sectional view showing a motor according to an embodiment of the invention.

### DETAILED DESCRIPTION OF THE INVENTION

The present invention will be apparent from the following detailed description, which proceeds with reference to the accompanying drawings, wherein the same references relate to the same elements.

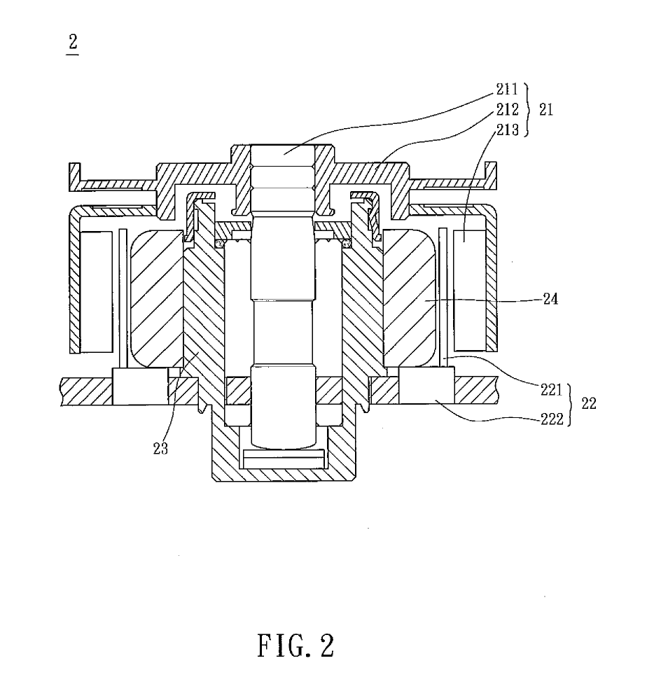

With reference to FIG. 2, a motor 2 according to an embodiment of the invention includes a rotor 21, a stator 22 and a bushing 23. The motor 2 can be applied to a fan. The rotor 21 has a shaft 211, a permeable shell 212 and a magnetic element 213. The shaft 211 is connected with the permeable shell 212 and is disposed in the bushing 23. In the embodiment, the shaft 211 can be connected with the permeable shell 212 by engaging, hooking or adhering. The magnetic element 213, which can be a magnetic ring, is disposed around the inner wall of the permeable shell 212.

The stator 22 has a coil 221 and a driving circuit board 222 coupled with the coil 221. The coil 221 is disposed corresponding to the magnetic element 213 and located between the bushing 23 and the magnetic element 213. In the embodiment, the coil 221 is a coreless coil.

The motor 2 further includes a magnetic body 24 disposed on the bushing 23 and corresponding to the coil 221 of the stator 22. The magnetic body 24 is located between the bushing 23 and the coil 221. In the embodiment, the magnetic body 24 is a magnetic ring and made of ferrite or permeable material such as soft magnet ferrite or permeable alloy.

When a voltage is applied to the coil 221 of the motor 2, the electromagnetic effect can be generated between the coil 221 and the magnetic element 213. In the embodiment, the electromagnetic effect can be improved by the configuration of the magnetic body 24. Accordingly, the motor 2 can reach the same performance with lower current so as to avoid the high frequency noise and reduce the heat generated by the coil. Due to the improved electromagnetic effect, the motor 2 can efficiently drive the magnetic element 213, the permeable shell 212 and the shaft 211 to rotate.

To be noted, the motor 2 of the invention can be applied to, for example but not limited to, a fan, an optical device or a vehicle device. In addition, the industrial design of the motor 2 is not limited to the above mentioned embodiment. In addition, the motor 2 can be modified based on the application functions and fields. For example, the shaft 211 may protrude from the permeable shell 212 to connect with other elements.

In summary, the motor of the invention has a magnetic body disposed between the stator and the bushing, so that the electromagnetic effect between the coil of the stator and the magnetic element of the rotor can be improved. Accordingly, the high frequency noise can be avoided. In addition, the improved electromagnetic effect allows the coil reaching the same performance with lower current. Therefore, the heat generated by the coil can be reduced so as to improve the performance of the motor.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor comprising:
a bushing;
a stator telescoped to the bushing;
a rotor having a shaft disposed in the bushing and a magnetic element disposed corresponding to the stator; and
a magnetic body disposed between the stator and the bushing.

2. The motor according to claim 1, wherein the magnetic body is made of ferrite, soft magnet ferrite, permeable alloy or permeable material.

3. The motor according to claim 1, wherein the magnetic body is a magnetic ring.

4. The motor according to claim 1, wherein the stator comprises a coil disposed corresponding to the magnetic body, and the magnetic body is disposed between the coil and the bushing.

5. The motor according to claim 4, wherein the coil is a coreless coil.

6. The motor according to claim 1, wherein the rotor further comprises a permeable shell.

7. The motor according to claim 6, wherein the shaft is connected with the permeable shell by engaging, hooking or adhering.

8. The motor according to claim 6, wherein the magnetic body is disposed around an inner wall of the permeable shell.

9. The motor according to claim 8, wherein the magnetic body is a magnetic ring.

10. The motor according to claim 1 being applied to a fan, an optical device or a vehicle device.
